(19) United States
(12) Patent Application Publication
(10) Pub. No.: US 2008/0257952 A1
(43) Pub. Date: Oct. 23, 2008

(54) System and Method for Conducting Commercial Transactions

(76) Inventor: Andre Luis Zandonadi, Minas Gerais (BR)

Correspondence Address: KAPLAN GILMAN GIBSON & DERNIER L.L.P., 900 ROUTE 9 NORTH, WOODBRIDGE, NJ, 07095, US

(21) Appl. No.: 11/736,893

(22) Filed: Apr. 18, 2007

(51) Int. Cl. G07F 19/00

(52) U.S. Cl. 235/379

(57) ABSTRACT

A system and method are disclosed which may include providing a processing center, at least one mobile device, and a third party device, wherein quantities of financial value are stored in accounts associated, respectively, with the at least one mobile device and the third party device; enabling communication between the at least one mobile device and the processing center; enabling communication between the third party device and the processing center; conducting at least one commercial transaction between the mobile device and the third party device; and employing the processing center as an intermediary for the commercial transaction.

### BACKGROUND OF THE INVENTION

The present invention relates to a system and method for conducting commercial transactions of any type.

### DESCRIPTION OF THE PRIOR ART

The adoption of mobile phone technology for the purpose of payment is described in European patent application EP 01102566. This patent refers to the input of data into a cash register and the transmission of the data to the mobile phone via a short-distance network. Once the customer confirms the payment information transmitted by the short-distance network using a mobile device, a payment instruction is generated and transmitted by the means of the mobile device. In this system, the amount that will be paid is confirmed by the customer before the payment instruction is generated in order to validate the customer identity.

In U.S. Pat. No. 7,069,001 to Rupp et al. the customer identity is authenticated by the mobile network authentication server, such as a Home Location Registry (HLR) in case of a Global System for Mobile Communications (GSM) network, using the subscriber identification module key and the authentication algorithm adopted in the mobile network. In the same application, the payment information is transmitted via a short distance network from the cash register to the mobile phone or entered in the cash register by the customer.

Another approach is disclosed in U.S. Pat. No. 7,124,937 to Myers et al., in which a transaction is conducted using two portable devices. A secure connection is established between the two portable devices to initiate a transaction. The transaction is approved by both portable devices and sent to a payment hub service for clearing purpose. The security is provided by a residing application installed in both portable devices.

The previous patents demand the proximity of the payee and the payer in order to fulfill a transaction. This condition restricts the use of cashless payment for non-presence purchases.

In U.S. Pat. No. 7,011,246 to Nanbu et al., a portable card reader is introduced that is aimed at the home delivery market. The payment is processed by the use of a plastic card, such as a credit card, in a card reader terminal. A similar schema is adopted by the credit card industry that adopts wireless card reader terminals to fulfill a cashless transaction. The current model presents two issues, which are: (a) the use of additional equipment and (b) the use of a plastic card.

Plastic cards are widely used, but incur shipment costs and are susceptible to fraud, such as by skimming—a process in which the cardholder's account information is electronically copied, or “skimmed”, off the card's magnetic stripe. The use of the skimmed information generates counterfeit payment cards that are, in turn, used for fraudulent transactions.

Thus, there is a need in the art for an improved system for conducting commercial transactions between devices, one or more of which may be wireless, that may be remotely located from one another.

### SUMMARY OF THE INVENTION

One or more embodiments of the present invention provide a secure, cost-effective and user-friendly method to conduct cashless transactions using at least one wireless mobile device, a processing center, and a third party device, which may be a second wireless mobile device.

The present invention also provides a method for conducting one or more cashless commercial transactions between mobile devices using a processing center as an intermediary. The mobile devices that are parties to the transaction may be proximate to or distant from one another.

A payment method is provided, which method may begin after a customer selects the goods or the services that he/she can pay either by cash, traditional credit card, store credit card, gift card or equivalent monetary means.

A mobile device used by a payee may be coupled to a Subscriber Identity Module (SIM) card. A retailer computer-readable software application may reside in the payee Subscriber Identity Module (SIM) Card. The payer mobile device may also be coupled to a Subscriber Identity Module (SIM) card which may house a consumer computer-readable software application. The computer-readable software may capture information that is dispatched to a processing center. In the consumer device, the application may also receive confirmation messages and display and/or store them.

The processing center may exchange purchase information with a payee and a payer via the Short Message Service Center (SMSC) available in the wireless network. The processing center may include a connectivity gateway, an authentication module, an encryption/decryption module, an authorization module, a clearing and settlement module, a processing center database and an integration gateway.

The payee can start a retailer application in his mobile device and input purchase information such as, but not limited to, payer alias, service type, purchase total amount and, when suitable, the number of payment terms into the computer-readable software application. The retailer application may then display a confirmation dialog to the payee who may confirm the purchase information that may be formatted as an application message and sent to the processing center by the retailer application. The processing center may then validate the payee and the payer identity and verify the authorization limits allowed for the payer and the payee using the data received from the payee. If the authorization limits are valid, the processing center may request that the payer provide a confirmation by dispatching an application message containing the purchase information (such as retailer name, purchase total amount, transaction identifier and, when suitable, the number of payment terms) to the payer. The payer may confirm the purchase information and input his personal password into his mobile device software application, herein referred as a consumer application. The consumer application may capture the confirmation information and send the same to the processing center. The processing center may receive the message, verify the payer password, generate an authorization number (which may be a unique number in the system for this authorization), and send a confirmation message both to the payer and to the payee's mobile device, which may contain the cashless electronic transaction authorization number. The confirmation message may contain a variety of information, such as the purchase price and other information, the transaction date, and one or more other identifiers and authorization codes.

One or more methods disclosed herein may improve upon the efficiency and security of existing payment methods using mobile devices, by using mobile device as the point-of-sale terminals to conduct cashless payments. The mobile device communication module may be operable to conduct communication with the processing center. The adoption of mobile phones or other mobile devices may replace other point-of-sale devices at the retailer facility.

One or more methods disclosed herein may enable a cashless payment to be made at any time and at any place where a signal is available, once the device is enabled to act as the point-of-sale terminal.

The computer readable software applications residing on Subscriber Identity Module (SIM) cards may include strong cryptographic capabilities that provide security for data stored on the cards and data communicated to and from the cards. Before any data transmission, an application message may be encrypted using a specific encryption algorithm installed in the Subscriber Identity Module (SIM) card. This procedure may operate to ensure a high level of confidentiality for every application message. The application message data may be exchanged through a standard Global System for Mobile Communications (GSM) network which, in turn, implements specific security methods for assuring: subscriber identity authentication, subscriber identity confidentiality, signaling data confidentiality and user data confidentiality, according to standard Global System for Mobile Communications (GSM) Recommendations 02.09, 02.17, 03.20 and 03.21. However, the present invention is not limited to any particular communication standard, or any particular data security standard. Indeed, the present invention is amenable to being employed in conjunction with various possible communication networks, protocols, and security mechanisms, and all such variations are intended to be included within the scope of the present invention.

Various embodiments may provide computer readable software applications for any mobile device. Since the computer readable software application resides on the Subscriber Identity Module (SIM) card, any mobile device can easily become part of the system. There is no need for the payee or payer to buy a new mobile device. The software application can be installed within the Subscriber Identity Module (SIM) Card though a Subscriber Identity Module (SIM) Card writer or an Over-the-Air (OTA) service provision or fabric installed by the Subscriber Identity Module (SIM) Card manufacturer. Any other available means may be used as well.

The method of the present invention can be applied for various kinds of payment transactions including traditional or non-traditional payment methods, including the purchase and sale of goods and services, financial transactions, or any other business transactions. Some examples of transactions that can be supported include credit card payment transactions, debit card payment transactions, prepaid card payment transactions, gift card transactions and/or other means of payment.

One aspect of the present invention provides a method for conducting one or more commercial transactions using two mobile devices that communicate with a processing center to process one or more funds transfer operations, which method may include the steps of: a retailer application capturing electronic purchase information, which is input into the retailer application by a payee in a payee mobile device, displaying the captured purchase information, capturing a payee confirmation, sending a payee identity and an authorization request to a processing center. The method may further include the processing center receiving the authorization request and the payee identity, verifying pre-authorized limits allowed for the payer and the payee and the payee identity by comparing the received captured purchase information, the captured payee confirmation, and the payee identity, with the pre-authorized limits and the pre-established payee identity. The method may further include the processing center generating a unique number for the electronic purchase and requesting a confirmation from the payer by dispatching an electronic purchase confirmation request containing the purchase information to a consumer application, if the payee identity is confirmed and the limits are within the pre-authorized limits. Alternatively, the processing center may generate an error message in the payee mobile device and/or in a payer mobile device, if the payee identity is not confirmed and/or if the limits are not within the pre-authorized limits. Where the error message is generated, the electronic purchase is then not completed.

The method may further include the consumer application receiving the electronic purchase confirmation request, displaying the purchase information in the payer mobile device, capturing the electronic purchase confirmation and a personal password inputted by the payer into the payer mobile device, and sending a purchase confirmation response to the processing center. The method may further include the processing center receiving the purchase confirmation response, verifying the payer identity and password and authorizing the electronic purchase, if the identity and password are valid; and the processing center generating a unique number for the electronic purchase authorization; generating a payment instruction to transfer the money from a payer account to a payee account and sending an electronic purchase confirmation message to both the payer and payee mobile devices.

According to one aspect, the present invention discloses a system that may include a processing center; at least one mobile device configured to communicate with the processing center, wherein a quantity of financial value is stored in an account associated with the mobile device; and wherein the mobile device is configured to conduct one or more commercial transactions with a third party device employing the processing center as an intermediary for the one or more transactions. Preferably, the mobile device and the third party device are located remotely from one another. Preferably, the at least one mobile device communicates with the processing center wirelessly, and the processing center facilitates the movement of at least some financial value from an account associated with the mobile device to the third party device. Preferably, the third party device is a mobile device that also communicates with the processing center wirelessly. Preferably, at least one mobile device is selected from the group consisting of: a cell phone; a notebook computer; and a Personal Digital Assistant (PDA). Preferably, the third party device is a second mobile device and is also capable of voice communication with the mobile device. Preferably, the plurality of devices in communication with the processing center are associated with respective users. Preferably, each user is one of group consisting of: a person, a business; a business cash register; an automatic teller machine (ATM); and an Internet commerce site. Preferably, a subscriber identification module (SIM) card is disposed in communication with the at least one mobile device. Preferably, the SIM card is incorporated within the mobile device. Preferably, the mobile device is a cell phone and the third party device is an ATM machine, wherein the processing center is operable to create a temporary account to store value for a transaction between the cell phone and the ATM machine; and wherein the processing center is operable to transfer the stored value from one of the cell phone and the ATM machine and the other of the cell phone and the ATM machine.

According to another aspect, the invention provides a method, that may include providing a processing center, at least one mobile device, and a third party device, wherein quantities of financial value are stored in accounts associated, respectively, with the at least one mobile device and the third party device; enabling communication between the at least one mobile device and the processing center; enabling communication between the third party device and the processing center; conducting at least one commercial transaction between the mobile device and the third party device; and employing the processing center as an intermediary for the commercial transaction. Preferably, the employing step includes: creating a temporary account accessible by the processing center to store value associated with the commercial transaction. Preferably, the conducting step includes: requesting a given transaction by the mobile device. Preferably, the conducting step further includes: confirming receipt of the request by the third party device. Preferably, the conducting step further includes: authorizing the given transaction by the processing center.

Preferably, the conducting step further includes upon receiving the authorization, performing at least one funds transfer operation as part of the given transaction. Preferably, the performing step includes crediting one of the account associated with the mobile device; and the account associated with the third party device; and debiting the other of the account associated with the mobile; and the account associated with the third party device. Preferably, the method further includes transmitting an indication of completion of the commercial transaction to at least one of the mobile device and the third party device. Preferably, the third party device is a store cash register in communication with the processing center, and preferably, the conducting step includes a user of the mobile device providing value to the store cash register; and crediting at least a portion of the provided value to the mobile device account. Preferably, the method further includes determining an initial credit amount for a user of the mobile device based on at least one of an average call volume and an average bill amount for the user; and providing the initial credit amount in the mobile device account.

Preferably, the conducting step includes transferring a first amount of value from a first mobile device account to the third party device as part of the commercial transaction; wherein the method further includes dividing the cost of the commercial transaction between the first mobile device account and a second mobile device account. Preferably, the dividing step includes transferring at least a portion of the first amount of value from the second mobile device account to the first mobile device account via the processing center. Preferably, the third party device is a store cash register that is located remotely from the mobile device and the conducting step preferably includes transferring at least a first amount of value from the mobile device to the store cash register; wherein the method further includes the mobile device identifying a person to the store cash register; and transferring currency having the first amount of value from the store cash register to the identified person. Preferably, the method further includes transferring a second amount of value from the mobile device to the store cash register to serve as a service fee for the commercial transaction. Preferably, the third party device is an automatic teller machine (ATM), and the conducting step preferably includes creating a temporary account by the processing center; transferring a given amount of value from the mobile device to the processing center for access from the ATM; storing the given amount of value in the temporary account; accessing the ATM by a user of the mobile device; and transferring currency having the given amount of value to the mobile device user at the ATM.

Preferably, the third party device is an Internet commerce site and wherein the conducting step includes transferring a given amount of value from the mobile device to a transaction account at the processing center; the Internet commerce site providing a service or product to a user of the mobile device; and a user of the mobile device authorizing release of the given amount of value from the processing center to the Internet commerce site. Preferably, the method includes performing a plurality of electronic funds transfers between the mobile device and the processing center for a respective plurality of commercial transactions; storing information about the plurality of commercial transactions at the processing center; and after completing the performing and storing steps, conducting communication between the processing center and the third party device to complete the plurality of commercial transactions. Preferably, the storing step includes buffering the commercial transaction information for subsequent use. Preferably, the step of completing the plurality of commercial transactions is scheduled so as to minimize processing delay times at the processing center.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a communication system able to conduct commercial transactions in accordance with the present invention;

FIG. 1A is a block diagram of the processing center of FIG. 1;

FIG. 2 is a block diagram showing the mobile device and the Subscriber Identity Module (SIM) card of FIG. 1 in greater detail;

FIG. 3 is a block diagram illustrating an exemplary flow of messages exchanged among the mobile devices, Short Message Service Center (SMSC), and the processing center of FIG. 1;

FIG. 4 is a flow diagram for the retailer application, which may reside in the payee mobile device, in accordance with embodiments of the present invention;

FIG. 5 is a block diagram illustrating the insertion of an encrypted application message into a short message in accordance with an example of the invention;

FIG. 6 is a flow diagram for the consumer application, which may reside in the payer mobile device in accordance with one exemplary embodiment of present invention;

FIG. 7A is a first portion of an exemplary flow diagram of the operation of the processing center of FIG. 1;

FIG. 7B is a second portion of the flow diagram of the operation of the processing center; and

FIG. 8 is a flow diagram summarizing a cashless payment method in accordance with an embodiment of the present invention.

### DETAILED DESCRIPTION OF THE INVENTION

A first embodiment of the present invention includes transactions between two parties, a payer and a payee, who may use respective portable electronic devices to communicate to a processing center in order to conduct cashless payment transactions.

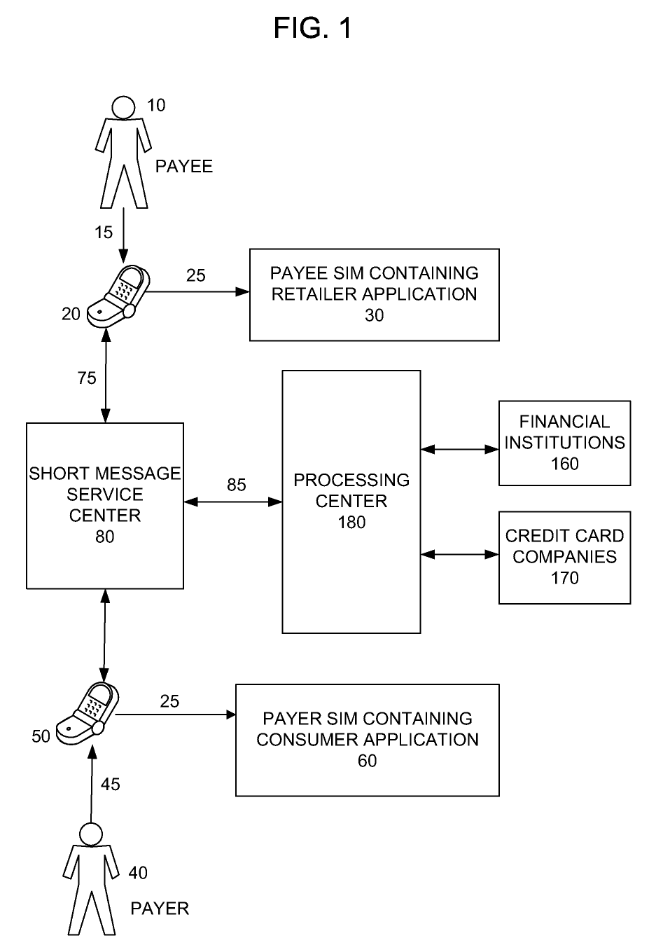

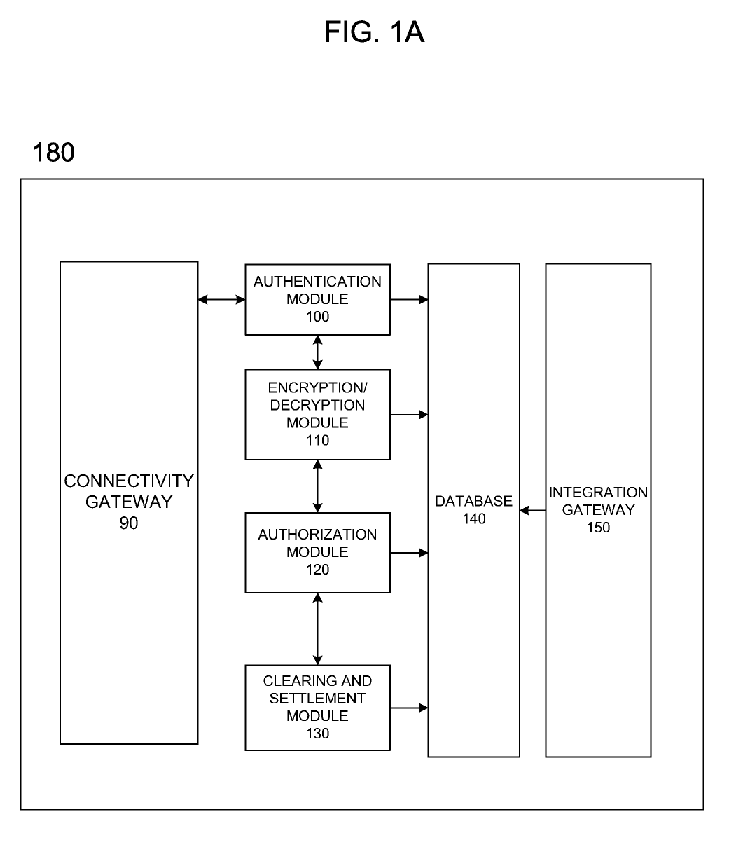

FIG. 1 shows the functional components of the invention, which may include a payee 10, mobile device 20, payee SIM 30, short message service center (SMSC) 80, processing center 180, one or more financial institutions 160, credit card companies 170, payer 40, mobile device 50, and/or payer SIM 60. In this embodiment, a payee 10 operates a portable electronic device such as mobile device 20. The financial exchange system of FIG. 1 may be employed to enable commercial transactions between a first device such as mobile device 20 and a third party device, such as mobile device 50, employing processing center 180 as intermediary therefore.

Herein, a commercial transaction may include a transaction between two devices which involves one or more transfers of funds and/or the provision of a service or product, which may be in exchange for the transfer of funds. For example, a commercial transaction could include electronically transferring funds from mobile device 50 to mobile device 20 of FIG. 1. A commercial transaction could further include controlling a final transfer of value to mobile device 20 or other device based on the provision of a service or product to payer 40. A commercial transaction may be cashless, or may include one or more funds transfers that involve a transfer of cash. Herein the term “third party device” may be a mobile device such as mobile device 20 of FIG. 1 or any device, whether mobile or fixed, capable of transmitting or receiving value using the system of FIG. 1, including but not limited to a cell phone, a notebook computer, a personal digital assistant (PDA), a cash register (such as for a store) with suitable communication capability, an Internet commerce site, and an automatic teller machine (ATM).

In the embodiment of FIG. 1, the payee 10 interfaces with the mobile device 20 by its keys and display, in this case represented by link 15. The mobile device 20 may be a portable device employing wireless communication such as: a Global System for Mobile Communications (GSM) mobile phone, a Universal Mobile Telecommunications System (UMTS) mobile phone, a Code Division Multiple Access (CDMA) mobile phone, a Wideband Code Division Multiple Access (W-CDMA) mobile phone or equivalent equipment. However, the present invention is not limited to using mobile devices employing the above-listed communication standards. Moreover, the present invention is not limited to the use of wireless communication. Devices employing wired communication means may also be employed for one or more devices participating in a commercial transaction that uses the processing center 180 as an intermediary. The mobile device 20 may be coupled to a Subscriber Identity Module (SIM) card 30 or an equivalent thereto. The payee mobile device 20 may be coupled to the payee Subscriber Identity Module (SIM) card 30, which may be a smart card equipped with microprocessor and memory, that securely stores a secret key that the standard Global System for Mobile Communications (GSM) network uses to identify a mobile phone subscriber in its network, as well as stores other information, such as telephone numbers, mobile phone configuration preferences, text messages and other information. SIM card 30 may include software that is customized for performing the functions of the present invention. However, alternatively, if available, existing software modules may be combined to perform a selection of the needed functions.

Each mobile device 20, 50 has software installed in its corresponding Subscriber Identity Module (SIM) card 30, 60 according to the function the corresponding SIM card performs in the overall process. For example, the functions may include being a “payee” and/or being a “payer”. In some embodiments, the “payee” is the party that begins a purchase electronic transaction and inputs the purchase information into his/her mobile device, which has the retailer application installed in its Subscriber Identity Module (SIM) card; and the “payer” is the party that confirms the purchase information and validates it using his personal password. The payer's mobile device contains the consumer application, which is installed in its Subscriber Identity Module (SIM) card 60. In such embodiments, payees may be retail stores, grocery stores, restaurants, etc while payers may be regular consumers, that is, individual persons. In other embodiments, a commercial transaction may be initiated by either a payee or a payer. Moreover, in such other embodiments, either of the payers or payee may be any of individual persons, retail outlets, machines such as ATMs or store cash registers, Internet commerce sites, or other entity capable of participating in a funds transfer or other form of commercial transaction.

In the embodiment of FIG. 1, the payee Subscriber Identity Module (SIM) card 30 contains a retailer application, which resides on the Subscriber Identity Module (SIM) Card memory. The retailer application is responsible for displaying a layout that the payee 10 inputs the purchase information into the payee mobile device 20. The Subscriber Identity Module (SIM) Card 30 and mobile device 20 communicate to each other via their contacts interface represented by link 25. SIM card 30 may be physically incorporated within mobile device 20. However, alternatively, SIM card 30 may be located externally to mobile device 20 while still being in communication therewith. The connection possibilities discussed above may also apply to mobile device 50 and SIM card 60.

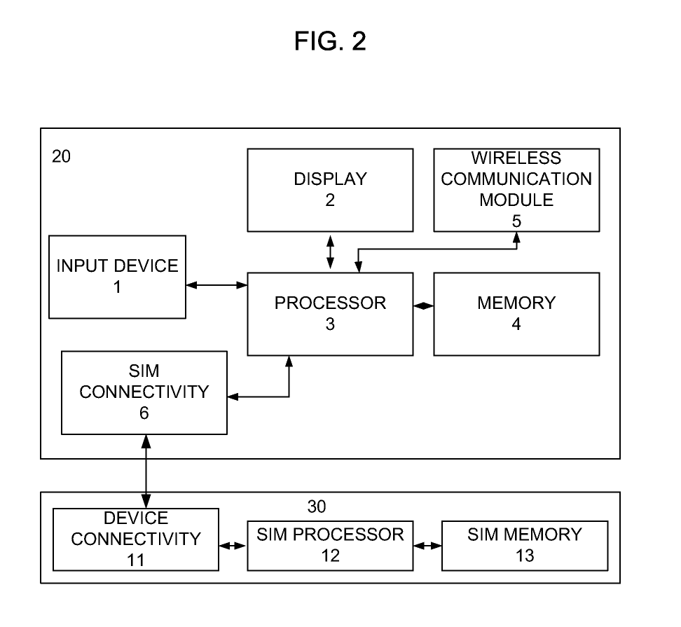

The mobile device 20 and SIM card 30 of FIG. 2 generally correspond to the like numbered devices of FIG. 1. FIG. 2 shows a mobile device 20 that includes a processor 3 (e.g., a microprocessor) coupled to a memory unit 4 comprising a computer readable medium, one or more input devices 1, a display 2, a wireless communication module 5, and connectivity 6 to SIM card 30. FIG. 2 also shows Subscriber Identity Module (SIM) (subscriber identity module) card 30. The memory unit 4 may include one or more memory devices working in association with each other or separately. The wireless communication module 5 exchanges wireless signals with the wireless network via a communication protocol, such as standard Global System for Mobile Communications (GSM), Wideband Code Division Multiple Access (W-CDMA) or an equivalent communication protocol. However, any suitable protocol may be used.

In FIG. 2, the one or more the one input devices 1 may include a keyboard, a touch sensitive pad, and a voice-recognition system or equivalent device. The display 2 may include a Liquid Crystal Display (LCD), Light Emitting Diodes (LED) and/or any other suitable display. The display 2 allows the Payer 40 and the Payee 10 to interact with one or more software applications operating within the system of FIG. 1 to conduct one or more commercial transactions.

In the embodiment of FIG. 2, the Subscriber Identity Module (SIM) card 30 securely stores information, according to Global System for Mobile Communications (GSM) technical specifications 3GPP TS 51.011, 3GPP TS 51.014, 3GPP TS 23.040, 3GPP TS 23.041 and 3GPP TS 23.048 or equivalent technical specification for the wireless technology adopted. However, the invention is not limited to foregoing specifications, and data may be stored in accordance with any suitable data storage protocol. The Subscriber Identity Module (SIM) card 30 may include connectivity 11 to device 20, Subscriber Identity Module (SIM) card processor 12 and the Subscriber Identity Module (SIM) card memory 13. The Subscriber Identity Module (SIM) card processor 12 and Subscriber Identity Module (SIM) card memory 13 may execute applications, according to Global System for Mobile Communications (GSM) technical specification 3GPP TS 43.019 or equivalent technical specification of the wireless technology adopted. However, the invention is not limited to executing applications according to the listed specifications. Indeed, processor 12 may execute software applications in accordance with any suitable specification. The Subscriber Identity Module (SIM) connectivity means 11 may be a smart card communication interface according to the ISO 7816 standard or equivalent standard according to the mobile device communication interface. It is noted that the present invention is not limited to the above-listed standards for communication between device 20 and SIM card 30 and that any suitable communication interface may be employed.

The Subscriber Identity Module (SIM) card memory unit 13 may use an electrical, magnetic or optical mechanism as a computer readable medium for data storage. Several technologies can be adopted as the computer readable medium, such as optical disk, memory chips (e.g., Random Access Memory (RAM) chip, Read Only Memory (ROM) chip, Electrically Erasable Programmable Read Only Memory (EEPROM) chip) or equivalent technology.

The Subscriber Identity Module (SIM) card 30 may provide a set of Application Programming Interfaces (API) for software application codification which is called Subscriber Identity Module (SIM) Application Programming Interfaces (API). The Global System for Mobile Communications (GSM) technical specification 3GPP TS 43.019 describes the functional capabilities and the information flow for the SIM API implemented on the Java Card 2.1 API. According to this specification, the Subscriber Identity Module (SIM) card 30 may instruct the portable electronic device 20 to execute a set of predefined functions. For example, the SIM card memory 13 may contain code for transmitting a purchase request from a portable electronic device to a card processor through a GSM network and code for receiving approval of the sale request, wherein the approval is sent from the card processor to the portable electronic device through the standard GSM network.

The payee mobile device 20 communicates with the Short Message Service Center (SMSC) 80 via a long distance wireless link, which can be a standard Global System for Mobile Communications (GSM) network 75 or equivalent network according to the wireless technology adopted. The Short Message Service Center (SMSC) 80 is a network element in the mobile network that stores and forwards short messages. A short message is a text message type that may be used to conduct data communication between one or more mobile devices and/or between a mobile device and a software application running on a communication node in a mobile network. The short message service is available on most digital mobile phones and other mobile devices, such as a Pocket Personal Computer (Pocket PC). The text size may vary according to the network configuration but the average size is 160 bytes. However, messages shorter than or longer than 160 bytes may be transmitted using the system and method of the present invention.

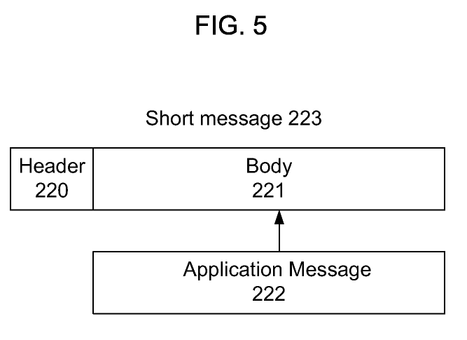

Referring to FIGS. 1 and 5, the short message may include a header 220 and a body 221. The short message header 220 contains information about its source and destination while the short message body 221 is composed of the application message which contains specific information about its operation and data. The application message 222 contains operation information and data for each electronic transaction. The application message is inserted in a short message, which is delivered to the processing center 180. In this context, the Short Message Service Center (SMSC) 80 is the entity responsible for carrying the short message 223 between the mobile devices 20, 50 and the processing center 180. In the embodiment of FIG. 1, short messages 223 generated by the retailer application are preferably sent to the processing center 180. Once a short message dispatch is requested by the retailer application, the short message 223 is delivered to the Short Message Service Center (SMSC) 80, which stores message 223 and forwards it to the processing center 180. In other embodiments, short message 223 could be transmitted to devices other than processing center 180.

With reference to FIG. 1A, the processing center 180 may include: the connectivity gateway 90, the authentication module 100, the encryption/decryption module 110, the authorization module 120, the clearing and settlement module 130, the processing center database 140, and the integration gateway 150. It will be appreciated that in other embodiments, processing center 180 could include fewer or more components than those shown in FIG. 1A.

In order to interconnect the processing center 180 and the Short Message Service Center (SMSC) 80, the connectivity gateway 90 of processing center 180 is used. Connectivity gateway 90 may serve as a gateway between the mobile network Short Message Service Center (SMSC) 80 and the processing center 180 infrastructures. The connectivity gateway 90 is responsible for encoding and decoding short messages that are exchanged between the processing center 180 and the mobile network Short Message Service Center (SMSC) 80. The encoding process represents the transformation of application messages 222 into short messages 223; and the decoding process represents the transformation of short messages 223 into application messages 222. The encoding and decoding steps are preferably performed because the Short Message Service Center (SMSC) 80 preferably processes short messages and the processing center 180 preferably processes application messages in order to conduct an electronic transaction, such as an electronic commercial transaction.

With reference to the embodiment of FIGS. 1 and 1A, the connectivity gateway 90 is integrated with the wireless network via the Short Message Service Center (SMSC) 80 through link 85. This link 85 can be a Transmission Control Protocol/Internet Protocol (TCP/IP), X.25 or equivalent. The link 85 carries short messages 223 using a communication protocol, such as the Short Message Peer-to-Peer Protocol (SMPP) or equivalent. The Short Message Peer-to-Peer Protocol (SMPP) protocol is an open, industry standard protocol designed to provide a flexible data communications interface between Short Message Centers, such as a Short Message Service Center (SMSC), standard Global System for Mobile Communications (GSM) Unstructured Supplementary Services Data (USSD) Server or other type of Short Message Centers and an application solution, in this case, the processing center 180. The link 85 security can be fortified using a Virtual Private Network (VPN). The use of a Virtual Private Network (VPN) increases the level of security by encrypting all the information exchanged between the parties. Depending upon the type of encryption algorithm applied the integrity and the confidentiality of each transaction between them can be increased. Several solutions can be applied for establishing a secure Virtual Private Network (VPN).

Turning to the other components of processing center 180, the authentication module 100 verifies whether the application message received from the connectivity gateway 90 has as a source a trusted third party registered in the processing center database 140. The authentication module 100 uses the mobile device identity specified in the short message to validate the source of the application message in the processing center database 140. In addition to this, the authentication module 100 also has the responsibility of checking the payer 40 personal password against the processing center database 140 for purchase confirmation operations.

The encryption/decryption module 110 is in charge of guaranteeing the data confidentiality of the application messages by encrypting or decrypting the data. It uses a cryptographic algorithm based on symmetric keys and seed exchanges. However, other cryptographic schemes can be used, according to the security requirements. The same algorithm may be implemented as part of the software applications residing on the Subscriber Identity Module (SIM) cards 30, 60, in order to decrypt the application messages received from the processing center 180 and encrypt the application messages that will be sent to processing center 180.

The authorization module 120 may approve or decline individual electronic commercial transactions according to pre-configured parameters. The approval process is based on business rules that are specified, for example, by partner companies, indicating whether the payer 40 account funds are available and whether the electronic transaction can be completed. During the authorization process, the payer or the payee account status and the authorization limits, among other specified parameters, are checked.

The clearing and settlement module 130 is responsible for transferring money from payer 40 account to the payee 10 account. The transfer of financial value can be performed at the time of the transaction or some time thereafter, according to the defined business rules set in the processing center 180. It is also possible to define whether the processing center 180 will charge additional fees such as processing fees or taxes in connection with the transaction.

The processing database 140 preferably contains all the business rules that apply to all accounts and to all participants (i.e. payers and/or payees) in electronic transactions conducted by processing center 180. In this context, such participants may be individual persons, stores, Internet commerce sites or other business entities as discussed elsewhere herein. Each application message in the processing center 180 preferably has a unique number that allows its identification in the processing center 180. When the authorization module 120 approves an electronic transaction, a new unique number, referred to herein as an authorization number, is assigned to the electronic transaction. These authorization numbers uniquely identify the electronic transaction in the processing center 180 and are used for auditing purposes and electronic transaction retrieval. Processing center 180 preferably provides a receipt for every successful electronic transaction wherein each receipt contains the authorization number for the corresponding transaction. The receipt for each transaction is preferably provided to payer 40 and payee 10 as an acknowledgment of a successfully completed electronic transaction.

With reference to FIGS. 1 and 1A, the integration gateway 150 is operable to interact with the external partners, such as the credit card companies 170 or financial institutions 160, which are referred to herein as external partners. Integration gateway 150 acts as an interface between the processing center 180 and the external partners, which allows the external partners 160, 170 to set specific parameters for each payee or payer. Parameters that can be set by the external partners may include, but are not limited to: authorization limits, applicable taxes, interest charges, and other applicable parameters. A financial institution is responsible for funding a commercial transaction, which may include a cashless operation. The initial amount of money in a payer account may be provided by a financial institution, such as a bank. The money provided can later be retrieved by deposits in the financial institution account. In some embodiments, the initial amount of money, or initial credit amount, that is provided to an account associated with a user (such as a payer or payee), to a mobile device, and/or to an account associated with the user or mobile device, may be determined based on a) an average call volume and/or b) an average bill amount for that user's mobile device. Upon determining the amount as described above, a financial institution may then proceed to credit the account.

The communication between the integration gateway 150 and the external partners 160, 170 may be carried out according to the ISO 8583 Protocol, the Standard for Financial Transaction Card Originated Messages. This specification is in accord with the International Organization for Standardization for systems that conduct electronic transactions. However, the invention is not limited to the use of the above-described communication protocol. Indeed other communication protocols may be employed for the communication between the processing center 180 and the external partners 160, 170.

An electronic, cashless payment may be conducted through a sequence of operations between the involved parties. These operations may be conducted between the parties by means of the mobile device communication module as short messages. The short messages are dispatched to a Short Message Service Center (SMSC) 80, which is responsible for forwarding the messages to the respective targeted entities.

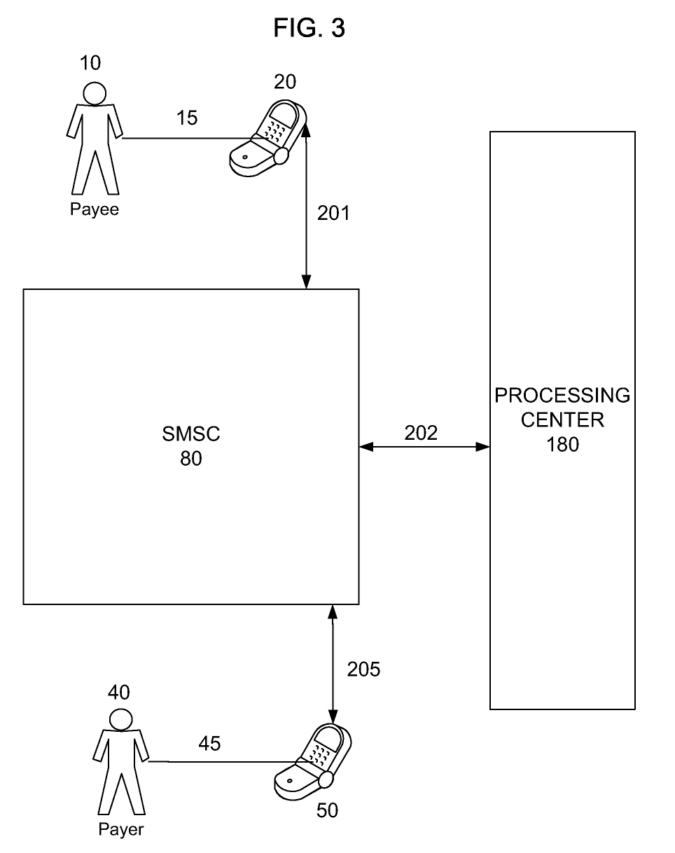

In FIG. 3 each labeled arrow represents a path, or portion of a path, along which data may be transmitted to conduct an operation in order to complete a cashless electronic transaction. After payee 10 starts the retailer application and inputs the purchase information through the mobile device 20 keyboard into the retailer application, a purchase authorization request may be sent along path 201/202 to the processing center 180. A “purchase authorization request” is an operation in which the retailer application sends a short message to the processing center 180 containing purchase information to be approved. The short message contains the purchase information, such as service type, purchase total amount (cost of the purchase), payer alias and when suitable, the number of payment terms. The transmission of the short message may be accomplished in two distinct phases: in the first phase, the short message is sent to the Short Message Service Center (SMSC) 80 along path 210, and then, in the second phase, the message is forwarded to the processing center 180 along path 202. When the short message is received by the processing center 180, processing center 180 validates the identity of payee 10 and sends a purchase confirmation request to payer 40 along path 202 to SMSC 80 and then along path 205 to mobile device 50. A “purchase confirmation request” is an operation in which the processing center 180 sends a short message to the consumer application containing the purchase information. Likewise, when processing the purchase confirmation request, the short message is first sent to the Short Message Service Center (SMSC) 80 along path 202 and then forwarded along path 205 to the consumer application operating in cooperation with mobile device 50. The short message is received by the consumer application in SIM card 60, which requests that the payer 40 confirm the purchase. The confirmation process may include the payer 40 submitting purchase information confirmation and a personal password into mobile device 50. In alternative embodiments other data transmission paths may be employed. For instance in an alternative embodiment, messaging could be conducted directly between mobile devices 20, 50 and processing center 180, so long as suitable functionality for processing such communication is provided within processing center 180 and the mobile devices 20, 50.

After the data is received in mobile device 50, the consumer application in SIM card 60 preferably sends a purchase confirmation response to the processing center 180 along paths 205 (to SMSC 80) and 202 (to processing center 180). A “purchase confirmation response” is an operation in which the consumer application in SIM card 60 sends a short message to the processing center 180 containing the confirmation of purchase information. Transmission of the purchase confirmation response may be executed in two phases. First the message is sent along path 205 to the Short Message Service Center (SMSC) 80 and then the message is sent along path 202 to the processing center 180. Upon receiving the purchase confirmation response, processing center 180 may conduct the authorization 120 and clearing and settlement 130 processes and preferably sends a successful-purchase confirmation message to the payer 40 and the payee 10. A “successful purchase confirmation” is an operation in which the processing center 180 sends short messages to payee 10 and payer 40 mobile devices 20 and 50 containing the purchase information and the purchase authorization number. The purchase receipt is a short message sent to the payee 10 and the payer 40 containing the purchase authorization number.

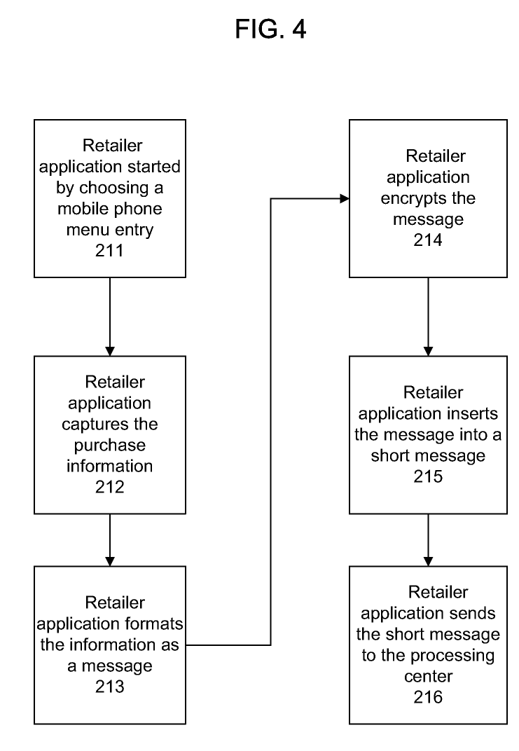

In FIG. 4 the retailer application is activated 211 by a menu selection done by the payee 10. It captures the purchase information 212 by interacting with payee 10 through the mobile device 20 display and input devices. Once the purchase information is gathered, the retailer application creates an application message, which is formatted according to the retailer application protocol 213. The generated application message is encrypted 214 to guarantee the data confidentiality and then is inserted into a short message 215. Finally, the retailer application sends 216 the short message containing the purchase authorization request 201, 202 to the processing center 180.

The insertion of the encrypted application message into a short message is presented in FIG. 5. The short message is composed of a header 220 and a body 221. The header 220 may include information about the sender, the receiver, the time stamp, the Short Message Service Center (SMSC) network address and/or others parameters. The body 221 may include the application message data to be transmitted. In this embodiment, after the retailer application (which may operate in SIM card 30) has encrypted the application message 222, the application message 222 is inserted into the short message body 221 in such a manner that the short message 223 can be transmitted to the processing center 180. When the short message 223 arrives, the processing center 180 extracts the encrypted application message 222 from the short message body 221.

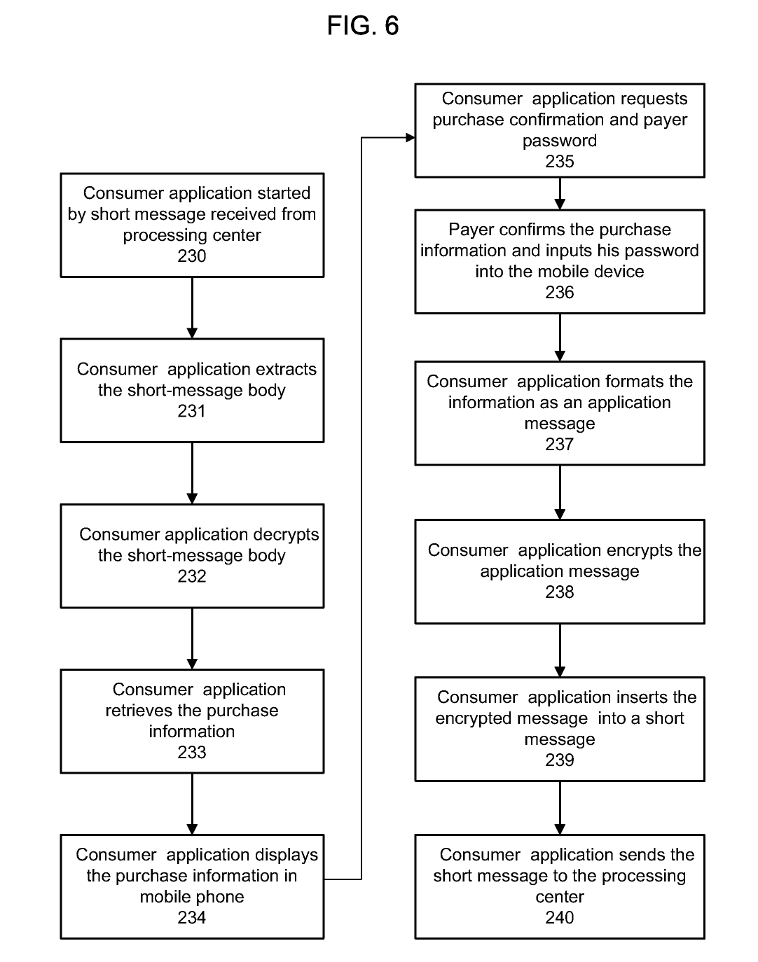

In FIG. 6 the consumer application (which may operate in SIM card 60) is activated through the arrival (230) of a short message 223 (which could, for instance, be a class 2 short message) sent by the processing center 180. After the short message arrives at SIM card 60, the consumer application extracts (231) the short message body 221 containing the encrypted application message 222 and decrypts it (232). The next step is to retrieve (233) its purchase information. The consumer application displays (234) the purchase information in the mobile device display and requests (235) that the payer 40 confirm the purchase information and input the payer's password into the consumer application. Once the payer has completed the confirmation process (236), the consumer application formats (237) a purchase confirmation response as an application message 237, which is encrypted (238) and inserted (239) into a short message body 221. Lastly, the consumer application sends (240) the short message to processing center 180.

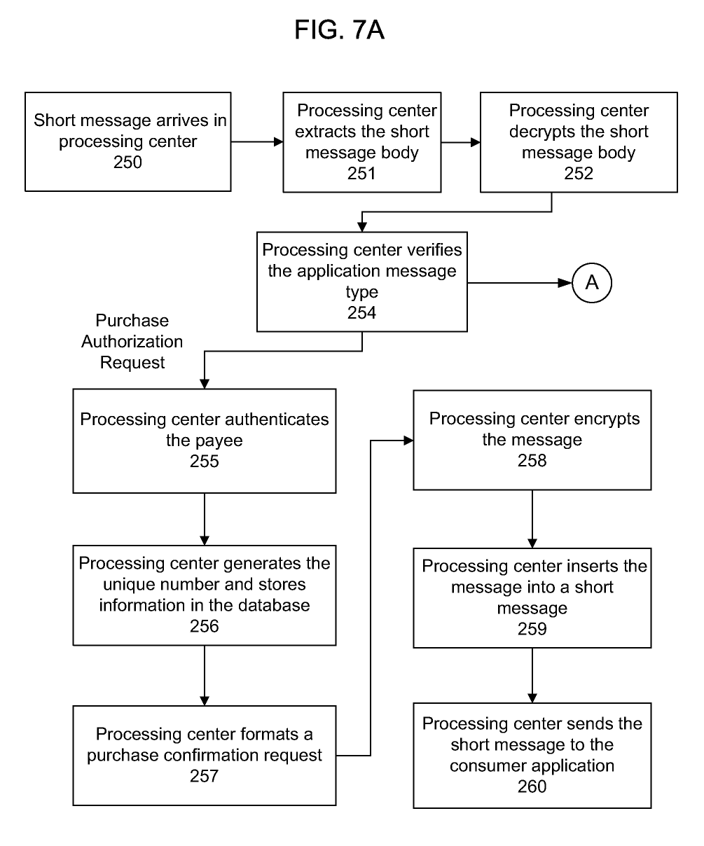

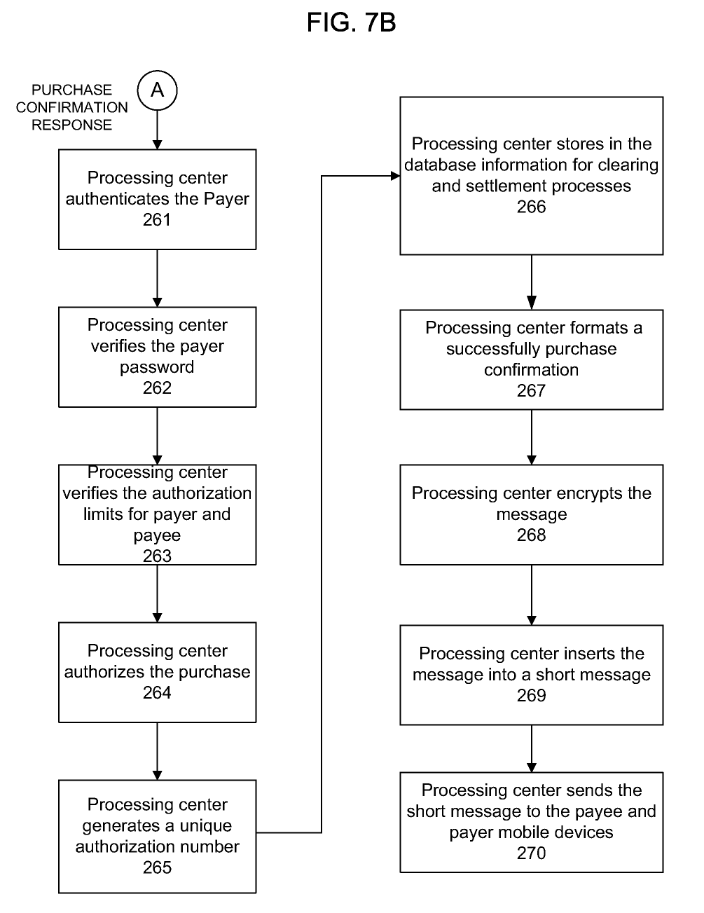

In the flow diagram of FIG. 7A, as soon as a short message arrives (250) in the processing center 180, the processing center 180 extracts (251) the body 221 of the message and decrypts (252) its contents. Thereafter, processing center 180 verifies (254) the message type. The processing center 180 can receive either a purchase authorization request, sent by the retailer application, which contains the purchase data to be authorized, or a purchase confirmation response, sent by the consumer application, which contains the purchase confirmation.

In the case where a purchase authorization request is received, the processing center 180 authenticates (255) the payee's alias. The payee's alias is an alternative identification for the real identity of payee 10 that is checked in the processing center database 140 in order to identify the payee 10. The alias is stored in the database 140 when the payee 10 account is created. The main purpose of the alias is to provide confidentiality for the payee 10. After authenticating payee 10, the processing center 180 generates (256) a unique number for the transaction, which can further be used for electronic transaction tracking purposes. In addition to this, the processing center 180 formats (257) a purchase confirmation request with the received data, encrypts (258) it, inserts (259) it into a short message body 221 and dispatches (260) a short message to the consumer application.

With reference to FIG. 7B, if the received short message 223 contains a purchase confirmation response, the processing center 180 authenticates (261) the payer 40 identity in a manner similar to that described above for payee 10, and verifies (262) the password contained in the short message body 221. If the password is confirmed, the processing center 180 verifies (263) the authorization limit for both payer 40 and payee 10 and authorizes (264) the purchase. After the authorization process, the processing center 180 generates (265) a unique authorization number and stores (266) the purchase information in the database 140 to conduct the clearing and settlement processes 130. Finally, it formats (267) a successful purchase confirmation, encrypts (268) the purchase confirmation 268, inserts (269) the purchase confirmation into a short message body 223 and dispatches (270) the short message 223 to both payer 40 and payee 10. The successful purchase confirmation may be composed of the purchase information and the purchase authorization number.

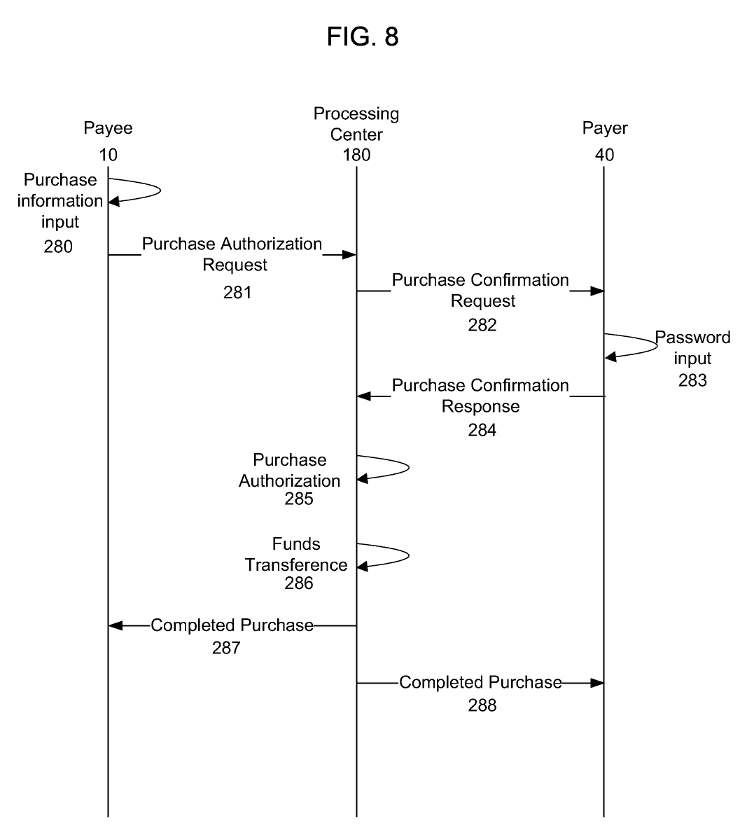

A preferred embodiment of the overall cashless payment method is summarized in the flow diagram of FIG. 8. The payee 10 initiates a purchase transaction by selecting the retailer application in the payee 10 mobile device 20 and providing (280) the purchase information. A purchase authorization request containing the purchase data is formatted and is sent (281) to the processing center 180. The processing center 180 validates the payee identity and sends (282) a purchase confirmation request to the payer 40. The payer 40 confirms the purchase information and inputs (283) his personal password into his mobile phone 20. A purchase confirmation response containing the payer personal password is formatted and is sent (284) to the processing center 180. The processing center 180 authenticates payer identity, verifies his personal password and authorizes (285) the purchase based on the parameters set in the authorization module. Following the authorization, the processing center 180 conducts the funds transfer 286 and sends (287) a successful purchase confirmation to payee 10 and to payer 40. If any of the above-discussed steps are not successfully completed, the purchase authorization process fails, and the purchase transaction is preferably not completed. In this case, both the payer 40 and the payee 10 receive an error message in their respective mobile devices 50, 20.

In the following, some specific variations of the general system configuration discussed in connection with FIGS. 1-8 are described. In one embodiment, the system of FIG. 1 may enable a user, such as payee 10, of a mobile device to transfer value in the form of cash (i.e. paper currency) to a financial account associated with the user or the user's mobile device using a store cash register, or other third party device as an intermediary. In this embodiment, a user 10 of mobile device 20 can provide value in the form of cash to a cashier having access to a store cash register. In this situation, the store cash register assumes the position of payer 40 in FIG. 1 and a mobile communication capability operating in conjunction with the store cash register fulfills the role of mobile device 50 of FIG. 1. A case is considered in which user 10 pays $50 for an item having a cost of $30 and wishes to have the remainder of the payment amount credited to a financial account associated with the user's mobile device, or otherwise stated, the user's mobile device account. The store cash register may then calculate the change or remainder amount of $20, and transmit this value, using mobile communication means 50 to processing center 180, in a manner previously described herein. It will be appreciated that the above transaction may be readily conducted in the reverse direction. Specifically, the user could receive cash from the store cash register, and in turn transmit value from the user's mobile device account to the store cash register's mobile device account. In this manner, a mechanism for readily converting between paper currency (or other form of value) and electronic value may be implemented using the system and method of the present invention.

Another example may involve a commercial transaction involving a transfer of value in exchange for a service or product, such as a restaurant meal. At the conclusion of the meal, or at any other suitable time, user 40 may transfer value to another user 10 (which may be the restaurant cash register) corresponding to the price of the meal and any associated taxes and gratuities. The mobile device accounts of users 10 and 40 may be suitably adjusted (that is, credited or debited in accordance with the transaction) in response to the electronic transfer of value between the two users. The example is here expanded to include the option of having one party to the meal contribute a portion of the meal cost. This contribution would represent a second transaction in which the status of the original user changes, when using FIG. 1 as a reference. We consider a case in which the total meal cost was $100 to user 40 above, and in which the second restaurant client will contribute $50 to user 40 to suitably share the cost of the meal.

Thus, the client referred to as user 40 above now becomes a payee 10. The second restaurant client now becomes a payer 40 in the system diagram of FIG. 1. Thus, the second restaurant client (the new payer 40) preferably transfers $50 using his mobile device 50 to the account of the payee's mobile device 20 using processing center 180, using a method discussed elsewhere herein. Thus, the system and method of the present invention may be beneficially employed to divide the cost of a meal, or other service or product between two or more consumers of the service or product in an accurate and efficient manner.

An example is considered in which it is desired to transfer money between two persons (first and second persons) using the system of FIG. 1 as an intermediary. In this example, payer 40 may be a money transferor, and payee 10 may be a store cash register (i.e. a third party device) with suitable means for communicating with SMSC 80 and processing center 180. As a first step in this process, payer 40 can transfer a quantity of value, corresponding to the amount of money sought to be transferred to the second person, to the electronic account of the store cash register. Upon confirming that the correct amount of value has in fact been received in its account, a user of the store cash register (payee 10 in the above-described electronic transfer) may transfer a quantity of cash, or other form of value, corresponding to the amount of the electronic value transfer (or “electronic funds transfer”) to the second person. In this manner, the system and method of the present invention may be employed as an alternative money wire transfer system. If necessary, payer 40 could be required to transfer additional value to the store cash register to serve as a service fee to the user of the store cash register (or other device) as payment for converting the transferred electronic value into cash for the second person.

An example is considered in which the system of FIG. 1 may enable a user of a mobile device to withdraw cash from the user's mobile device electronic account using a conventional ATM (automatic teller machine). A user, who may be payer 10 in the configuration of FIG. 1, may communicate with processing center 180 using mobile device 50 and may request a withdrawal transaction from the user's mobile device account. A PIN (personal identification number) may optionally be entered by the user to authenticate the identity of the user and/or of the mobile device being employed. The user also preferably employs device 50 to specify the amount of the intended cash withdrawal.

If the user is authenticated and the requested transaction amount is authorized, processing center 180 may create a temporary account at, or accessible to, processing center 180, for access by an ATM, or other suitable machine. The processing center 180 may then transfer value to the temporary account. The amount of value transferred may equal the requested withdrawal amount or may exceed this amount to ensure an ability to pay any needed transaction fees imposed by the processing center, the ATM, and/or other entity. Thus, an amount of value is stored in the temporary account that preferably either equals or exceeds the amount of the anticipated cash withdrawal. Thereafter, the user accesses the ATM and preferably enters information to identify the temporary account in which value has been stored and/or to otherwise authenticate his identity to the ATM and/or to the processing center 180. The user preferably also enters authorization information such as a PIN number and/or other security information. The ATM then preferably communicates with processing center 180 to verify the information entered by the user, to ensure that sufficient funds are available in the temporary account to cover the amount of the cash withdrawal, and to finally authorize the completion of the transaction. Such final authorization may include seeking authorization from the user via the user's mobile device during the pendency of the cash transaction at the ATM. If all of the information is properly verified, the ATM machine may dispense a quantity of cash corresponding to the amount specified in the user's withdrawal request. Thereafter, processing center 180 may debit the user's temporary account by the amount of the cash withdrawal and by any applicable fees, and suitably credit the account of the owner or administrator of the ATM machine.

Yet another application of the systems and methods disclosed herein involves having processing center 180 serve as an intermediary for a commercial transaction between a user of a mobile device and an Internet commerce site. When serving as an intermediary in this manner, a transaction account may be established in processing center 180 for storing value associated with the commercial transaction for which processing center 180 serves as an intermediary. Such a transaction account may be either temporary or permanent, depending upon the needs of the parties to the commercial transaction(s). Moreover, a plurality of transaction accounts may be established if needed for one or more commercial transactions.

In this embodiment, a user 40 of a mobile device 50 may transfer a given amount of value from the mobile device account to a transaction account at the processing center 180. Before, during, or after the transfer of value from the mobile device 50, the Internet commerce site may provide a service or product to the user 40, or other entity in exchange for the transferred value. Once user 40 is satisfied that the Internet commerce site has fully performed its portion of the commercial transaction (whether providing a service or product), user 40 may transmit a message from mobile device 50 to processing center 180 to authorize release of the transferred value from the transaction account (or other account in processing center 180) to the Internet commerce site. In this manner, the system of FIG. 1 may serve as a convenient mechanism for enabling commerce between Internet users and Internet commerce sites. Moreover, use of the transaction account may enable a two-phase payment in exchange for a service or product. In this situation, the first phase may involve taking the preliminary step of transferring value into a transaction account which neither party to the commercial transaction can easily withdraw value from. Next, a second step may include the user authorizing release of the value, or funds, in the transaction account to the Internet commerce site only upon being satisfied that the commerce site's part of the commercial transaction has been fulfilled.

FIG. 8 shows a sequence of steps associated with completing one commercial transaction from start to finish. However, during periods where the communication infrastructure of FIG. 1 experiences high demand, and correspondingly high cost, efficiency may be obtained by postponing selected commercial transactions, or portions of such transactions, until communication bandwidth demand and cost declines. Thus, where a plurality of commercial transactions, with multiple parties, are contemplated, various portions of the transactions may be buffered, and then completed later in the most efficient and cost-effective manner possible.

A case is considered where a plurality of commercial transactions between a payer 40 and a payee 10 are contemplated. First, a plurality of funds transfers between payer 40 and processing center 180 may be conducted. Such funds transfers may include any needed requests, authorizations, and authentications as have been previously discussed herein. The data for the plural funds transfers may be stored at processing center 180, prior to conducting any activity with payee 10. In this example, it is assumed that at the time the data for the plural funds transfers are stored at processing center 180, communication with payee 10 in connection with the various funds transfers would be very expensive owing to communication demand at that time. Thus, it is preferred to wait until such demand declines to an acceptable level.

Upon determining that communication traffic and cost has declined to an acceptable level, processing center 180 may initiate completion of the commercial transactions for which information was stored earlier. Specifically, processing center 180 may conduct various communication steps with mobile device 20 and payee 10 to complete the transactions begun earlier. Details of the various requests, authorizations, and authentications etc. needed to complete the various transactions were discussed earlier in this specification and are thus not discussed in this section. Buffering the various transactions in this manner may enable the transactions to be concluded more efficiently and less expensively than if the various transactions were completed consecutively and in accordance with a fixed schedule. It may be seen that various portions of the multiple commercial transactions may be scheduled so as to minimize processing delay times at the processing center 180 and/or communication delay times at various points within the communication infrastructure connecting payer 40, processing center 180, and payee 10.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system, comprising:
a processing center;
at least one mobile device configured to communicate with the processing center, wherein a quantity of financial value is stored in an account associated with the mobile device; and
wherein the mobile device is configured to conduct one or more commercial transactions with a third party device employing the processing center as an intermediary for the one or more transactions.

2. The system of claim 1 wherein the mobile device and the third party device are located remotely from one another.

3. The system of claim 1 wherein the at least one mobile device communicates with the processing center wirelessly, and wherein the processing center facilitates the movement of at least some financial value from an account associated with the mobile device to the third party device, and wherein the third party device is a mobile device that also communicates with the processing center wirelessly.

4. The system of claim 1 wherein at least one said mobile device is selected from the group consisting of: a cell phone; a notebook computer; and a Personal Digital Assistant (PDA).

5. The system of claim 1 wherein the third party device is a second mobile device and is also capable of voice communication with the mobile device.

6. The system of claim 1 wherein the plurality of devices in communication with the processing center are associated with respective users.

7. The system of claim 6 wherein each said user is one of group consisting of: a person, a business; a business cash register; an automatic teller machine (ATM); and an Internet commerce site.

8. The system of claim 1 wherein a subscriber identification module (SIM) card is disposed in communication with said at least one mobile device.

9. The system of claim 8 wherein the SIM card is incorporated within the mobile device.

10. The system of claim 1 wherein the mobile device is a cell phone and the third party device is an ATM machine,
a. wherein the processing center is operable to create a temporary account to store value for a transaction between the cell phone and the ATM machine; and
b. wherein the processing center is operable to transfer the stored value from one of the cell phone and the ATM machine and the other of the cell phone and the ATM machine.

11. A method, comprising:
a. providing a processing center, at least one mobile device, and a third party device, wherein quantities of financial value are stored in accounts associated, respectively, with the at least one mobile device and the third party device;
b. enabling communication between the at least one mobile device and the processing center;
c. enabling communication between the third party device and the processing center;
d. conducting at least one commercial transaction between the mobile device and the third party device; and
e. employing the processing center as an intermediary for the commercial transaction.
f. The method of claim 11 wherein the employing step comprises:
g. creating a temporary account accessible by the processing center to store value associated with the commercial transaction.
h. The method of claim 11 wherein the conducting step comprises:
i. requesting a given transaction by the mobile device.

12. The method of claim 13 wherein the conducting step further comprises:
a. confirming receipt of the request by the third party device.

13. The method of claim 13 wherein the conducting step further comprises:
a. authorizing the given transaction by the processing center.

14. The method of claim 15 wherein the conducting step further comprises:
a. upon receiving the authorization, performing at least one funds transfer operation as part of the given transaction.

15. The method of claim 16 wherein the performing step comprises:
a. crediting one of the account associated with the mobile device; and the account associated with the third party device; and
b. debiting the other of the account associated with the mobile; and the account associated with the third party device.

16. The method of claim 17 further comprising:
a. transmitting an indication of completion of the commercial transaction to at least one of the mobile device and the third party device.
b. The method of claim 11 wherein the third party device is a store cash register in communication with the processing center, and wherein the conducting step comprises:
c. a user of the mobile device providing value to the store cash register; and
d. crediting at least a portion of the provided value to the mobile device account.
e. The method of claim 11 further comprising:
f. determining an initial credit amount for a user of the mobile device based on at least one of an average call volume and an average bill amount for the user; and
g. providing the initial credit amount in the mobile device account.

17. The method of claim 11 wherein the conducting step comprises:
a. transferring a first amount of value from a first mobile device account to the third party device as part of the commercial transaction;
b. wherein the method further comprises:
c. dividing the cost of the commercial transaction between the first mobile device account and a second mobile device account.

18. The method of claim 21 wherein the dividing step comprises:
a. transferring at least a portion of the first amount of value from the second mobile device account to the first mobile device account via the processing center.

19. The method of claim 21 wherein the third party device is a store cash register that is located remotely from the mobile device and wherein the conducting step comprises:
a. transferring at least a first amount of value from the mobile device to the store cash register; wherein the method further comprises:
b. the mobile device identifying a person to the store cash register; and
c. transferring currency having said first amount of value from the store cash register to the identified person.

20. The method of claim 23 further comprising:
a. transferring a second amount of value from the mobile device to the store cash register to serve as a service fee for the commercial transaction.

21. The method of claim 21 wherein the third party device is an automatic teller machine (ATM), and wherein the conducting step comprises:
a. creating a temporary account by the processing center;
b. transferring a given amount of value from the mobile device to the processing center for access from the ATM;
c. storing the given amount of value in the temporary account;
d. accessing the ATM by a user of the mobile device; and
e. transferring currency having the given amount of value to the mobile device user at the ATM.

22. The method of claim 21 wherein the third party device is an Internet commerce site and wherein the conducting step comprises:
a. transferring a given amount of value from the mobile device to a transaction account at the processing center;
b. the Internet commerce site providing a service or product to a user of the mobile device; and
c. a user of the mobile device authorizing release of the given amount of value from the processing center to the Internet commerce site.

23. The method of claim 21 wherein the method comprises:
a. performing a plurality of electronic funds transfers between the mobile device and the processing center for a respective plurality of commercial transactions;
b. storing information about the plurality of commercial transactions at the processing center; and
c. after completing the performing and storing steps, conducting communication between the processing center and the third party device to complete the plurality of commercial transactions.

24. The method of claim 27 wherein the storing step comprises:
a. buffering the commercial transaction information for subsequent use.

25. The method of claim 27 wherein the step of completing the plurality of commercial transactions is scheduled so as to minimize processing delay times at the processing center.
